(19) United States
(12) Patent Application Publication
(10) Pub. No.: US 2025/0036492 A1
(43) Pub. Date: Jan. 30, 2025

(54) DELAYED DELIVERY OF IRRELEVANT NOTIFICATIONS

(71) Applicant: International Business Machines Corporation, Armonk, NY (US)

(72) Inventors: Valerie Lampkin, Saint George Island, FL (US); AVINASH ASTHANA, Jersey City, NJ (US); NEIL DELIMA, Scarborough (CA); Tiberiu Suto, Franklin, NY (US); Suman Patra, KOLKATA (IN)

(21) Appl. No.: 18/360,036

(22) Filed: Jul. 27, 2023

(51) Int. Cl. G06F 9/54

(52) U.S. Cl. CPC G06F 9/542

(57) ABSTRACT

In an approach to delayed delivery of irrelevant notifications, one or more computer processors determine an activity of a user. One or more computer processors calculate a focus score associated with the activity. One or more computer processors receive an incoming notification. One or more computer processors determine the focus score exceeds a pre-defined focus threshold. One or more computer processors calculate a relevance score of the incoming notification. One or more computer processors determine the relevance score exceeds a pre-defined relevance threshold. Based on the focus score exceeding the pre-defined focus threshold and the relevance score exceeding the pre-defined relevance threshold, one or more computer processors deliver the incoming notification at an opportune time.

### BACKGROUND OF THE INVENTION

The present invention relates generally to the field of electronic communication, and more particularly to delayed delivery of irrelevant notifications.

In information technology, a notification system is a combination of software and hardware that provides a means of delivering a message to one or more recipients. The notification system commonly shows activity related to an account. Such systems constitute an important aspect of modern Web applications. For example, a notification system can send an e-mail announcing when a computer network will be down for a scheduled maintenance. The complexity of the notification system may vary. Complicated notification systems are used by businesses to reach critical employees. Emergency notification systems may take advantage of modern information technologies. Governments use them to inform people of upcoming danger. Enterprises use them for communication between employees. In mobile phones and smartphones, dedicated hardware, such as a notification LED, is sometimes included to deliver messages or notify users.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

### SUMMARY

Embodiments of the present invention disclose a computer-implemented method, a computer program product, and a system for delayed delivery of irrelevant notifications. The computer-implemented method may include one or more computer processors determining an activity of a user. One or more computer processors calculate a focus score associated with the activity. One or more computer processors receive an incoming notification. One or more computer processors determine the focus score exceeds a pre-defined focus threshold. One or more computer processors calculate a relevance score of the incoming notification. One or more computer processors determine the relevance score exceeds a pre-defined relevance threshold. Based on the focus score exceeding the pre-defined focus threshold and the relevance score exceeding the pre-defined relevance threshold, one or more computer processors deliver the incoming notification at an opportune time.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a notification delay program, on a client computing device within the distributed data processing environment of FIG. 1, for delayed delivery of irrelevant notifications, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

In today's work environment, a large percentage of conversations are held online, via electronic communication applications such as email, text, instant messaging, and web meetings, as well as over the phone. The use of application notifications is widespread among desktop and mobile applications today to keep users informed of the existence of new application features and to direct users to points of interest within the application. Often, the notifications can distract a user, especially if the user is working on something that requires their full attention or sharing their screen during a presentation, web meeting, or screen recording.

Embodiments of the present invention recognize that efficiency may be gained by reducing user distraction during a period of high productivity. Embodiments of the present invention recognize that efficiency may be gained by identifying a project on which a user is focused and delaying notifications that are not relevant to that project. Embodiments of the present invention also recognize that improvements to notification processes may be made by prioritizing notifications relevant to the user's focus and those of high importance to the user. Implementation of embodiments of the invention may take a variety of forms, and exemplary implementation details are discussed subsequently with reference to the Figures.

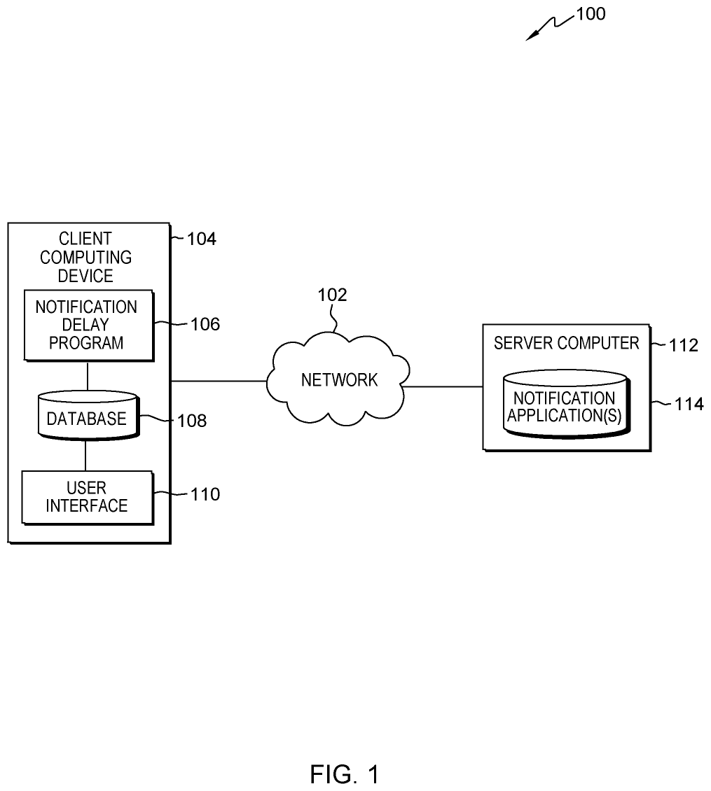

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

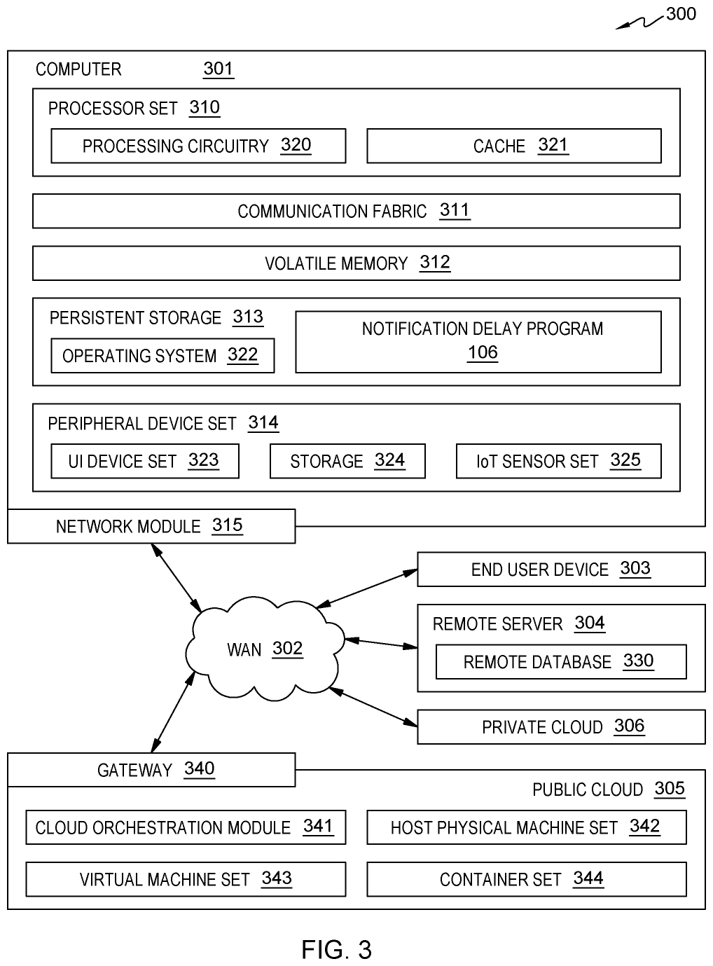

Distributed data processing environment 100 includes client computing device 104 and server computer 112 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between client computing device 104, server computer 112, and other computing devices (not shown) within distributed data processing environment 100. Distributed data processing environment 100 may be implemented in computing environment 300, shown in FIG. 3.

Client computing device 104 can be one or more of a laptop computer, a tablet computer, a smart phone, smart watch, a smart speaker, or any programmable electronic device capable of communicating with various components and devices within distributed data processing environment 100, via network 102. Client computing device 104 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 104 may be integrated into a vehicle. For example, client computing device 104 may be a heads-up display in the windshield of the vehicle. In an embodiment where client computing device 104 is integrated into the vehicle, client computing device 104 includes a programmable, embedded Subscriber Identity Module (eSIM) card (not shown) that includes a unique identifier of the vehicle in addition to other vehicle information. In general, client computing device 104 represents one or more programmable electronic devices or combination of programmable electronic devices capable of executing machine readable program instructions and communicating with other computing devices (not shown) within distributed data processing environment 100 via a network, such as network 102. Client computing device 104 includes notification delay program 106, database 108, and an instance of user interface 110. Client computing device 104 may include internal and external hardware components, as depicted and described in further detail with respect to computer 301 of FIG. 3.

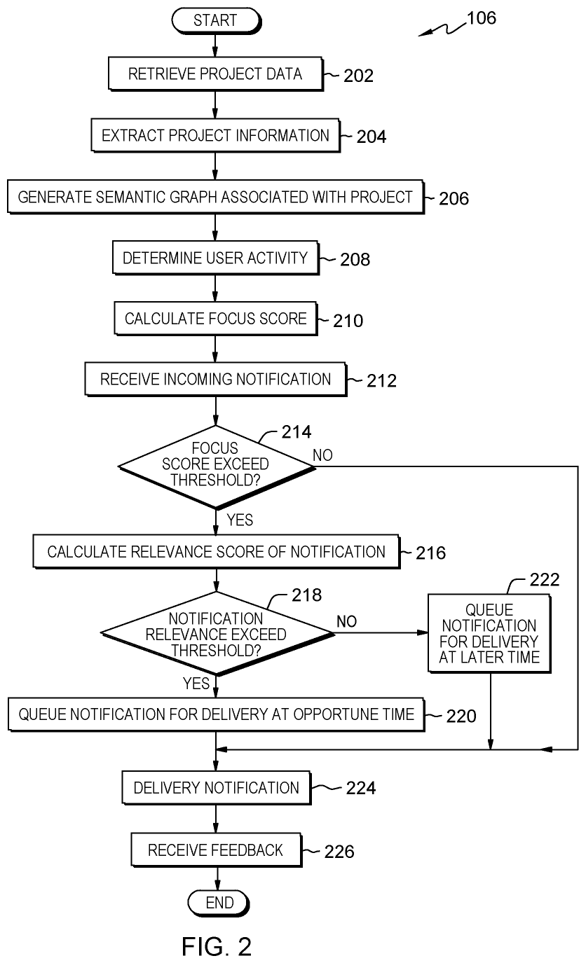

Notification delay program 106 delays delivery of notifications that are not associated with a task or topic on which a user is currently focused, while prioritizing notifications that are relevant to the focused activity. In the depicted embodiment, notification delay program 106 resides on client computing device 104. In another embodiment, notification delay program 106 may reside elsewhere within distributed data processing environment 100, for example, on server computer 112, provided that notification delay program 106 has access to client computing device 104 and database 108, via network 102. Notification delay program 106 retrieves project data and extracts project information. Notification delay program 106 generates a semantic graph associated with the project. Notification delay program 106 determines a user activity. Notification delay program 106 calculates a focus score associated with the activity. Notification delay program 106 receives an incoming notification. Notification delay program 106 determines whether the focus score exceeds a pre-defined threshold. If notification delay program 106 determines the focus score exceeds a pre-defined threshold, then notification delay program 106 calculates a relevance score of the notification. If the notification relevance score exceeds a pre-defined threshold, then notification delay program 106 queues the notification for delivery at an opportune time. If the notification relevance score does not exceed the pre-defined threshold, then notification delay program 106 queues the notification for delivery at a later time. Notification delay program 106 delivers the notification. Notification delay program 106 receives feedback associated with the notification. Notification delay program 106 is depicted and described in further detail with respect to FIG. 2.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of delayed delivery of irrelevant notifications. These embodiments may also include periodic reminders of such recording and monitoring throughout the course of any such use. Certain embodiments may also include regular (e.g., daily, weekly, monthly) reminders to the participating parties that they have consented to being recorded and monitored for delayed delivery of irrelevant notifications and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

In the depicted embodiment, database 108 resides on client computing device 104. In another embodiment, database 108 may reside elsewhere within distributed data processing environment 100, provided that notification delay program 106 has access to database 108, via network 102. A database is an organized collection of data. Database 108 can be implemented with any type of storage device capable of storing data and configuration files that can be accessed and utilized by notification delay program 106 such as a database server, a hard disk drive, or a flash memory. Database 108 stores information used by and generated by notification delay program 106. Database 108 stores calculated focus scores and relevance scores. Database 108 also stores pre-defined thresholds for focus scores and for relevance scores. In an embodiment, database 108 stores a unique pre-defined threshold for a focus score associated with each project with which a user is involved. In an embodiment, database 108 may store historical data from previous processing of notifications for the user of client computing device 104 and/or other users of notification delay program 106. For example, database 108 may store information associated with the user's previous projects. In another example, database 108 may store information associated with the user's previous writing style, which notification delay program 106 deduces using a machine learning algorithm. Additionally, database 108 stores feedback received from the user for use with a machine learning algorithm. Further, database 108 stores user messages, emails, calendars, schedules, etc., which may have originated from notification application(s) 114.

Database 108 also stores a user profile associated with the user of client computing device 104. The profile may include, but is not limited to, name, address, phone number, email address, an account number, an employer, a job role, a job family, a business unit association, a job seniority, a job level, a resume, a medical record, a social network affiliation, etc. The user profile may also include user preferences, such as work environment preferences, for example, priority contacts such that the user prefers to be interrupted by a message by those contacts, etc. The user profile may also include binary classifiers, i.e., classifiers that classify text as either relevant or not relevant to the user's work products and/or interests. Notification delay program 106 may train a binary classifier using positive examples from one or more work items of the user of client computing device 104, such as an issue tracking ticketing system or a calendar entry, and negative examples from a plurality of other users. In an embodiment, notification delay program 106 pre-trains a statistical language model and fine tunes the statistical language model to train the classifier. In an embodiment, notification delay program 106 trains the binary classifier with a transcript marked by the user as not relevant after receiving an excerpt.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Notification delay program 106 enables the authorized and secure processing of personal data. Notification delay program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Notification delay program 106 provides information regarding personal data and the nature (e.g., type, scope, purpose, duration, etc.) of the processing. Notification delay program 106 provides the user with copies of stored personal data. Notification delay program 106 allows the correction or completion of incorrect or incomplete personal data. Notification delay program 106 allows the immediate deletion of personal data.

User interface 110 provides an interface between notification delay program 106, notification application(s) 114, and a user of client computing device 104. In one embodiment, user interface 110 is mobile application software. Mobile application software, or an “app,” is a computer program designed to run on smart phones, tablet computers and other mobile devices. In one embodiment, user interface 110 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, user interface 110 enables a user of client computing device 104 to receive notifications from notification application(s) 114 after delivery by notification delay program 106. In an embodiment, user interface 110 enables a user of client computing device 104 to provide feedback to notification delay program 106 on the processing of notifications. In an embodiment, user interface 110 enables a user of client computing device 104 to enter a user profile associated with notification program 106.

Server computer 112 can be a standalone computing device, a management server, a web server, a mobile computing device, or any other electronic device or computing system capable of receiving, sending, and processing data. In other embodiments, server computer 112 can represent a server computing system utilizing multiple computers as a server system, such as in a cloud computing environment. In another embodiment, server computer 112 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 104 and other computing devices (not shown) within distributed data processing environment 100 via network 102. In another embodiment, server computer 112 represents a computing system utilizing clustered computers and components (e.g., database server computers, application server computers, etc.) that act as a single pool of seamless resources when accessed within distributed data processing environment 100. Server computer 112 includes notification application(s) 114. Server computer 112 may include internal and external hardware components, as depicted and described in further detail with respect to computer 301 of FIG. 3.

Notification application(s) 114 are one or more of a plurality of software applications that include the function of sending a notification to user. For example, notification application(s) 114 may include, but are not limited to, an email application, an instant messaging application, a text message application, a web meeting application, a website, a news application, etc.

FIG. 2 is a flowchart depicting operational steps of notification delay program 106, on client computing device 104 within distributed data processing environment 100 of FIG. 1, for delayed delivery of irrelevant notifications, in accordance with an embodiment of the present invention.

Notification delay program 106 retrieves project data (step 202). In an embodiment, notification delay program 106 retrieves one or more of user messages, emails, calendars, schedules, etc., associated with one or more of the work products associated with the user from database 108. In an embodiment, notification delay program 106 retrieves metadata associated with the retrieved project data. For example, notification delay program 106 retrieves timestamps from received emails.

Notification delay program 106 extracts project information (step 204). In an embodiment, notification delay program 106 parses the retrieved project data for information associated with one or more projects on which the user is working and/or to which the user is assigned. In an embodiment, notification delay program 106 uses one or more natural language processing (NLP) techniques and/or one or more natural language understanding (NLU) techniques to determine important projects and deadlines from the retrieved data. For example, notification delay program 106 may extract the text “sales presentation due by 3:00 pm on January 10” from a user's messages. In another example, notification delay program 106 may extract the text “proposal for client A has to be received before noon tomorrow” from a user's email.

Notification delay program 106 generates a semantic graph associated with a project (step 206). In an embodiment, notification delay program 106 generates a semantic graph with content associated with items the user has open on client computing device 104. In an embodiment, notification delay program 106 dynamically updates the semantic graph as the user is working on a project to link content to the project. For example, the user participates in a monthly sales meeting, and, during that meeting, a sales report is presented which contains a compilation of sales data from the previous four weeks. Next month, while the user is compiling the previous four weeks of data for the next report, notification delay program 106 links the semantic graph to the previous report. In an embodiment, notification delay program 106 generates a unique semantic graph for each project in the workload of the user.

Notification delay program 106 determines a user activity (step 208). In an embodiment, while the user is working on a document, notification delay program 106 determines if the current activity is related to or associated with a particular project. For example, notification delay program 106 may use a cosine similarity model to determine if the document the user is currently working on is associated with a project. In another example, notification delay program 106 may use a back of words model to determine if the current document is associated with a project. In an embodiment, notification delay program 106 determines that the activity that user of client computing device 104 is engaged in is driving a vehicle.

Notification delay program 106 calculates a focus score associated with the activity (step 210). In an embodiment, notification delay program 106 calculates a focus score to determine whether the user is in a period of high productivity, i.e., deeply focused on the determined activity and/or project. In an embodiment, notification delay program 106 monitors the open files, documents, websites, etc., to determine whether the user continues working on the activity or if the user is also working on another project. In an embodiment, notification delay program 106 analyzes typing patterns of the user to determine, for example, whether the user is consistently working on one particular document. In an embodiment, notification delay program 106 analyzes data from one or more wearable devices associated with the user, such as client computing device 104 or other wearable devices (not shown in FIG. 1), to monitor cognitive load of the user, as activity in the brain can be measured through changes in the body's physiology. For example, notification delay program 106 monitors the user's heartrate and/or blood pressure to determine whether the user is concentrating on a particular task and/or whether the user is experiencing stress, potentially associated with a deadline. In an embodiment, notification delay program 106 may analyze webcam feed to determine whether the user is consistently using client computing device 104, and is, therefore, in a period of high productivity. For example, notification delay program 106 may analyze webcam images to determine if the user leaves the room or makes a phone call. In an embodiment, notification delay program 106 may use eye gaze detection to determine whether the user is deeply focused on the determined activity and/or project. For example, notification delay program 106 may determine the user is focused on various areas of the screen associated with client computing device 104 and the contents of the screen in those areas. In an embodiment, notification delay program 106 continually monitors the user such that notification delay program 106 dynamically updates the focus score.

In an embodiment, notification delay program 106 performs the following steps to calculate the focus score:

Notification delay program 106 records the time the user is engaged in an activity. In an embodiment, notification delay program 106 determines the time at which the user begins to work on a particular document, topic, project, etc. Notification delay program 106 continues to monitor the duration of time spent on the activity.

Notification delay program 106 uses one or more NLP and/or NLU techniques, and/or visual recognition, to determine a class, or type, of the engaged activity each time the user performs an action. For example, notification delay program 106 determines whether the user is creating a presentation, drafting an email reply, solving an urgent ticket, etc.

Notification delay program 106 analyzes the semantic graph of one or more projects to determine whether the class of the engaged activity is related to a project. For example, notification delay program 106 determines whether the user is browsing a website related to a project versus an unrelated website. If notification delay program 106 does not find the activity class in the semantic graph, i.e., if the activity was not previously linked to a particular task or other activity, then notification delay program 106 marks the activity as a distraction from the project. Continuing the previous example, if notification delay program 106 determines the user opens and works on a file for a project not related to the sales report, then notification delay program 106 determines the current activity is a distraction. In an embodiment, when notification delay program 106 determines an activity is a distraction, notification delay program 106 may also determine that the user has shifted focus, for example to an activity that has higher priority, based on the semantic graph associated with that activity.

In an embodiment, notification delay program 106 determines the total time spent on a distraction. In the embodiment, notification delay program 106 calculates the focus score during a time window as the ratio of time spent on the project divided by total time spent on distractions. In another embodiment, notification delay program 106 counts the number of times the user is engaged in an activity determined to be a distraction. In the embodiment, notification delay program 106 calculates the focus score during a time window by determining whether a total number of times the user is engaged in distractions exceeds a pre-defined threshold.

Notification delay program 106 receives an incoming notification (step 212). In an embodiment, when one or more of notification application(s) 114 send a notification, notification delay program 106 receives the incoming notification. For example, if a user sends an email to an email application associated with the user of client computing device 104, then notification delay program 106 receives the notification of the incoming email. In an embodiment, notification delay program 106 intercepts the incoming notification such that notification application(s) 114 does not deliver the notification to the user.

Notification delay program 106 determines whether the focus score exceeds a pre-defined threshold (decision block 214). In an embodiment, notification delay program 106 retrieves the pre-defined focus score threshold from database 108 and compares the previously calculated focus score to the pre-defined threshold. A focus score that exceeds the pre-defined schedule indicates the user is currently in a period of high productivity.

If notification delay program 106 determines the focus score exceeds a pre-defined threshold (“yes” branch, decision block 214), then notification delay program 106 calculates a relevance score of the notification (step 216). In an embodiment, notification delay program 106 analyzes the incoming notification to determine the relevance of the incoming notification to the project on which the user is currently focused. For example, a message from a teammate that is part of the team working on the project may have a higher relevance than a message from another coworker. In an embodiment, notification delay program 106 uses one or more NLP and/or NLU techniques to analyze the incoming notification for relevance to the topic of the project on which the user is currently focused. In an embodiment, notification delay program 106 maps both relevant people associated with a project, as well as identifying conversation points in the incoming notification and analyzing the conversation points to determine whether they map to the project on which the user is focused.

In an embodiment, notification delay program 106 calculates the relevance score of a notification by performing a topic analysis on the incoming notification as well as the activity on which the user is currently focused to determine how closely the topics match, either directly or semantically. In an embodiment, notification delay program 106 determines the role of the sender of the notification. For example, if notification delay program 106 determines the sender is a collaborator or a team member, then notification delay program 106 assigns a higher score. Further, in an embodiment, notification delay program 106 determines the urgency of the notification by analyzing keywords and sentiment in the notification, as would be recognized by a person of skill in the art, to determine whether any urgency is indicated in the notification. In an embodiment, notification delay program 106 assigns each of the attributes described above, i.e., the topic match, the sender identification, and the determined urgency, a numeric value of 1 to 10. In the embodiment, if the sum of the three scores exceeds a pre-defined threshold, then notification delay program 106 flags the notification as relevant. In an embodiment, notification delay program 106 adjusts the pre-defined threshold based on a reinforcement learning feedback mechanism, as will be discussed with respect to step 226.

Notification delay program 106 determines whether the notification relevance score exceeds a pre-defined threshold (decision block 218). In an embodiment, notification delay program 106 retrieves the pre-defined relevance score threshold from database 108 and compares the previously calculated relevance score to the pre-defined threshold. A relevance score that exceeds the pre-defined threshold indicates a likelihood that the incoming notification is relevant to the topic or project on which the user is currently focused.

If the notification relevance score exceeds a pre-defined threshold (“yes” branch, decision block 218), then notification delay program 106 queues the notification for delivery at an opportune time (step 220). In an embodiment, since the relevance score indicates the incoming notification is relevant to the project on which the user is currently focused, notification delay program 106 determines an optimal time to interject the incoming notification into the workflow of the user. For example, while the user is typing, notification delay program 106 may wait to deliver the notification to the user until the user finishes typing a paragraph instead of while the user is in the middle of a sentence, such that the notification causes less disruption to the focus of the user. In an embodiment, notification delay program 106 encodes a degree of relevance into the notification alert, thus modifying the alert to ensure a notification of high relevance is not missed. For example, notification delay program 106 may modify the alert to trigger the operating system to provide a louder and/or different tone or beep than normal. In another example, notification delay program 106 may modify the alert to add a visual factor to make the alert more prominent, such as placing the alert in the middle of the screen instead of in the corner of the screen.

If the notification relevance score does not exceed the pre-defined threshold (“no” branch, decision block 218), then notification delay program 106 queues the notification for delivery at a later time (step 222). In an embodiment, if notification delay program 106 determines that the incoming notification is not relevant to the project on which the user is focused, then notification delay program 106 delays delivery of the incoming notification until a time at which the focus score does not exceed the pre-defined threshold, i.e., until a time when the user will not be distracted by the notification. In an embodiment, if notification delay program 106 determines the incoming notification is of high importance or value to the user, even though it may not be relevant to the user's focus, then notification delay program 106 sets an appropriate priority to the notification.

Responsive to queuing the notification for an opportune time or for a later time, or responsive to determining the focus score does not exceed the pre-defined threshold (“no” branch, decision block 214), notification delay program 106 delivers the notification (step 224). In an embodiment, notification delay program 106 delivers the incoming notification as appropriate with the calculated focus score and/or relevance score. In an embodiment, notification delay program 106 triggers the one or more applications of notification application(s) 114 to deliver the notification at an appropriate time. In an embodiment where the incoming notification is of a phone call, notification delay program 106 triggers the application to deliver the incoming notification to voicemail.

Notification delay program 106 receives feedback associated with the notification (step 226). In an embodiment, the user can provide feedback to notification delay program 106 via user interface 110. The feedback can include, but is not limited to, a description or listing of one or more notifications that notification delay program 106 processed appropriately and/or whether any notifications were false positives. In an embodiment, notification delay program 106 uses the feedback as training data for supervised machine learning, such that notification delay program 106 continues to improve the accuracy of the determination of which notifications are distractions and which are relevant to the project on which the user is focused in the future. In an embodiment, notification delay program 106 prompts the user to input feedback in user interface 110 at a time when notification delay program 106 determines the focus score does not exceed the pre-defined threshold.

In an example scenario of the use of notification delay program 106, Person A, a technical consultant, is working on three projects for different clients in a team setting. Person A has a deliverable due in three hours for one of the three projects. Notification delay program 106 recognizes the imminent deadline, as discussed with respect to step 204, and activates to recognize incoming notifications associated with the project with the deadline. Notification delay program 106 also identifies team members working on the project with the deadline and flags team members that are working with Person A on multiple projects. Notification delay program 106 prevents the delivery of notifications that are not relevant to the project with the deadline from reaching Person A while the focus score of Person A exceeds the pre-defined threshold, as discussed with respect to step 222. Notification delay program 106 delivers notifications that are relevant to the final deliverable submission. Thus, notification delay program 106 helps Person A to complete the deliverable while joining relevant calls and seeing relevant emails and instant messages from the appropriate team members that are working on the project. Notification delay program 106 does not deliver a stray message from a friend, colleague, or application that does not pertain to the subject matter of the user's current focus.

FIG. 3 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as notification delay program 106 for validating and filtering MR content. In addition to notification delay program 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and notification delay program 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in notification delay program 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in notification delay program 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining, by one or more computer processors, an activity of a user;
calculating, by one or more computer processors, a focus score associated with the activity;
receiving, by one or more computer processors, an incoming notification;
determining, by one or more computer processors, the focus score exceeds a pre-defined focus threshold;
calculating, by one or more computer processors, a relevance score of the incoming notification;
determining, by one or more computer processors, the relevance score exceeds a pre-defined relevance threshold; and
based on the focus score exceeding the pre-defined focus threshold and the relevance score exceeding the pre-defined relevance threshold, delivering, by one or more computer processors, the incoming notification at an opportune time.

2. The computer-implemented method of claim 1, further comprising:
retrieving, by one or more computer processors, data associated with one or more projects, wherein the one or more projects are associated with the user, and wherein the activity of the user is associated with at least one of the one or more projects;
extracting, by one or more computer processors, project information from the retrieved data using one or more natural language processing techniques;
determining, by one or more computer processors, one or more important projects and deadlines from the extracted data; and
generating, by one or more computer processors, a semantic graph for each of the one or more projects using the extracted project information.

3. The method of claim 2, wherein calculating the focus score associated with the activity further comprises:
recording, by one or more computer processors, a duration of time the user is engaged in the activity;
determining, by one or more computer processors, a class of the activity each time the user performs an action associated with the activity;
analyzing, by one or more computer processors, the semantic graph of the one or more projects to determine whether the class of the activity is related to at least one project of the one or more projects;
based on determining the class of the activity is not related to the at least one project of the one or more projects, marking, by one or more computer processors, the activity as a distraction; and
calculating, by one or more computer processors, a ratio of time the user is engaged in the activity divided by total time spent on the distraction.

4. The computer-implemented method of claim 1, further comprising:
determining, by one or more computer processors, the relevance score does not exceed the pre-defined relevance threshold; and
based on the focus score exceeding the pre-defined focus threshold and the relevance score not exceeding the pre-defined relevance threshold, delaying, by one or more computer processors, delivery of the incoming notification to a later time.

5. The computer-implemented method of claim 4, wherein delaying the delivery of the incoming notification to the later time further comprises:
determining, by one or more computer processors, a time when the focus score does not exceed the pre-defined focus threshold.

6. The computer-implemented method of claim 1, further comprising:
receiving, by one or more computer processors, feedback associated with the delivered incoming notification from the user; and
training, by one or more computer processors, a machine learning algorithm with the received feedback.

7. The method of claim 1, wherein calculating the focus score associated with the activity includes analyzing at least one of: a typing pattern of the user, data from one or more wearable devices associated with the user, a webcam feed, and an eye gaze of the user.

8. A computer program product comprising:
one or more computer readable storage media;
program instructions, stored on at least one of the one or more computer readable storage media, to determine an activity of a user;
program instructions, stored on at least one of the one or more computer readable storage media, to calculate a focus score associated with the activity;
program instructions, stored on at least one of the one or more computer readable storage media, to receive an incoming notification;
program instructions, stored on at least one of the one or more computer readable storage media, to determine the focus score exceeds a pre-defined focus threshold;
program instructions, stored on at least one of the one or more computer readable storage media, to calculate a relevance score of the incoming notification;
program instructions, stored on at least one of the one or more computer readable storage media, to determine the relevance score exceeds a pre-defined relevance threshold; and
based on the focus score exceeding the pre-defined focus threshold and the relevance score exceeding the pre-defined relevance threshold, program instructions, stored on at least one of the one or more computer readable storage media, to deliver the incoming notification at an opportune time.

9. The computer program product of claim 8, further comprising:
program instructions, stored on at least one of the one or more computer readable storage media, to retrieve data associated with one or more projects, wherein the one or more projects are associated with the user, and wherein the activity of the user is associated with at least one of the one or more projects;
program instructions, stored on at least one of the one or more computer readable storage media, to extract project information from the retrieved data using one or more natural language processing techniques;
program instructions, stored on at least one of the one or more computer readable storage media, to determine one or more important projects and deadlines from the extracted data; and
program instructions, stored on at least one of the one or more computer readable storage media, to generate a semantic graph for each of the one or more projects using the extracted project information.

10. The computer program product of claim 9, wherein the program instructions to calculate the focus score associated with the activity comprise:
program instructions, stored on at least one of the one or more computer readable storage media, to record a duration of time the user is engaged in the activity;
program instructions, stored on at least one of the one or more computer readable storage media, to determine a class of the activity each time the user performs an action associated with the activity;
program instructions, stored on at least one of the one or more computer readable storage media, to analyze the semantic graph of the one or more projects to determine whether the class of the activity is related to at least one project of the one or more projects;
based on determining the class of the activity is not related to the at least one project of the one or more projects, program instructions, stored on at least one of the one or more computer readable storage media, to mark the activity as a distraction; and
program instructions, stored on at least one of the one or more computer readable storage media, to calculate a ratio of time the user is engaged in the activity divided by total time spent on the distraction.

11. The computer program product of claim 8, further comprising:
program instructions, stored on at least one of the one or more computer readable storage media, to determine the relevance score does not exceed the pre-defined relevance threshold; and
based on the focus score exceeding the pre-defined focus threshold and the relevance score not exceeding the pre-defined relevance threshold, program instructions, stored on at least one of the one or more computer readable storage media, to delay delivery of the incoming notification to a later time.

12. The computer program product of claim 11, wherein the program instructions to delay the delivery of the incoming notification to the later time further comprises:
program instructions, stored on at least one of the one or more computer readable storage media, to determine a time when the focus score does not exceed the pre-defined focus threshold.

13. The computer program product of claim 8, further comprising:
program instructions, stored on at least one of the one or more computer readable storage media, to receive feedback associated with the delivered incoming notification from the user; and
program instructions, stored on at least one of the one or more computer readable storage media, to train a machine learning algorithm with the received feedback.

14. The computer program product of claim 8, wherein program instructions to calculate the focus score associated with the activity include analyzing at least one of: a typing pattern of the user, data from one or more wearable devices associated with the user, a webcam feed, and an eye gaze of the user.

15. A computer system comprising:
one or more computer processors;
one or more computer readable memories; and
one or more computer readable storage media;
program instructions, stored on at least one of the one or more computer readable storage media for execution by at least one of the one or more computer processors via at least one of the one or more memories, to determine an activity of a user;
program instructions, stored on at least one of the one or more computer readable storage media for execution by at least one of the one or more computer processors via at least one of the one or more memories, to calculate a focus score associated with the activity;
program instructions, stored on at least one of the one or more computer readable storage media for execution by at least one of the one or more computer processors via at least one of the one or more memories, to receive an incoming notification;
program instructions, stored on at least one of the one or more computer readable storage media for execution by at least one of the one or more computer processors via at least one of the one or more memories, to determine the focus score exceeds a pre-defined focus threshold;
program instructions, stored on at least one of the one or more computer readable storage media for execution by at least one of the one or more computer processors via at least one of the one or more memories, to calculate a relevance score of the incoming notification;
program instructions, stored on at least one of the one or more computer readable storage media for execution by at least one of the one or more computer processors via at least one of the one or more memories, to determine the relevance score exceeds a pre-defined relevance threshold; and
based on the focus score exceeding the pre-defined focus threshold and the relevance score exceeding the pre-defined relevance threshold, program instructions, stored on at least one of the one or more computer readable storage media for execution by at least one of the one or more computer processors via at least one of the one or more memories, to deliver the incoming notification at an opportune time.

16. The computer system of claim 15, further comprising:
program instructions, stored on at least one of the one or more computer readable storage media for execution by at least one of the one or more computer processors via at least one of the one or more memories, to retrieve data associated with one or more projects, wherein the one or more projects are associated with the user, and wherein the activity of the user is associated with at least one of the one or more projects;
program instructions, stored on at least one of the one or more computer readable storage media for execution by at least one of the one or more computer processors via at least one of the one or more memories, to extract project information from the retrieved data using one or more natural language processing techniques;
program instructions, stored on at least one of the one or more computer readable storage media for execution by at least one of the one or more computer processors via at least one of the one or more memories, to determine one or more important projects and deadlines from the extracted data; and
program instructions, stored on at least one of the one or more computer readable storage media for execution by at least one of the one or more computer processors via at least one of the one or more memories, to generate a semantic graph for each of the one or more projects using the extracted project information.

17. The computer system of claim 16, wherein the program instructions to calculate the focus score associated with the activity comprise:
program instructions, stored on at least one of the one or more computer readable storage media for execution by at least one of the one or more computer processors via at least one of the one or more memories, to record a duration of time the user is engaged in the activity;
program instructions, stored on at least one of the one or more computer readable storage media for execution by at least one of the one or more computer processors via at least one of the one or more memories, to determine a class of the activity each time the user performs an action associated with the activity;
program instructions, stored on at least one of the one or more computer readable storage media for execution by at least one of the one or more computer processors via at least one of the one or more memories, to analyze the semantic graph of the one or more projects to determine whether the class of the activity is related to at least one project of the one or more projects;
based on determining the class of the activity is not related to the at least one project of the one or more projects, program instructions, stored on at least one of the one or more computer readable storage media for execution by at least one of the one or more computer processors via at least one of the one or more memories, to mark the activity as a distraction; and
program instructions, stored on at least one of the one or more computer readable storage media for execution by at least one of the one or more computer processors via at least one of the one or more memories, to calculate a ratio of time the user is engaged in the activity divided by total time spent on the distraction.

18. The computer system of claim 15, further comprising:
program instructions, stored on at least one of the one or more computer readable storage media for execution by at least one of the one or more computer processors via at least one of the one or more memories, to determine the relevance score does not exceed the pre-defined relevance threshold; and
based on the focus score exceeding the pre-defined focus threshold and the relevance score not exceeding the pre-defined relevance threshold, program instructions, stored on at least one of the one or more computer readable storage media for execution by at least one of the one or more computer processors via at least one of the one or more memories, to delay delivery of the incoming notification to a later time.

19. The computer system of claim 18, wherein the program instructions to delay the delivery of the incoming notification to the later time further comprises:
program instructions, stored on at least one of the one or more computer readable storage media for execution by at least one of the one or more computer processors via at least one of the one or more memories, to determine a time when the focus score does not exceed the pre-defined focus threshold.

20. The computer system of claim 15, further comprising:
program instructions, stored on at least one of the one or more computer readable storage media for execution by at least one of the one or more computer processors via at least one of the one or more memories, to receive feedback associated with the delivered incoming notification from the user; and
program instructions, stored on at least one of the one or more computer readable storage media for execution by at least one of the one or more computer processors via at least one of the one or more memories, to train a machine learning algorithm with the received feedback.
